(19) United States
(12) Patent Application Publication
(10) Pub. No.: US 2020/0333787 A1
(43) Pub. Date: Oct. 22, 2020

(54) MARINE SURFACE DRONE AND METHOD FOR CHARACTERISING AN UNDERWATER ENVIRONMENT IMPLEMENTED BY SUCH A DRONE

(71) Applicant: IXBLUE, Saint-Germain-en-Laye (FR)

(72) Inventors: Christophe CORBIERES, Saint-Germain-en-Laye (FR); Maxence RIOBLANC, Saint-Germain-en-Laye (FR); Guillaume MATTE, Saint-Germain-en-Laye (FR); Frédéric MOSCA, Saint-Germain-en-Laye (FR)

(21) Appl. No.: 16/956,839

(22) PCT Filed: Dec. 20, 2018
(86) PCT No.: PCT/FR2018/053448

§ 371 Date: Jun. 22, 2020

(30) Foreign Application Priority Data
Dec. 22, 2017 (FR) 1763137

(51) Int. Cl. G05D 1/02; G05D 1/00; G01S 15/96; G01S 15/89; G01S 7/524; G06T 7/70

(52) U.S. Cl. CPC G05D 1/0206; G05D 1/0094; G01S 15/96; G01S 7/5273; G01S 7/524; G06T 7/70; G01S 15/89

(57) ABSTRACT

Disclosed is a marine surface drone including: - an on-board multi-beam sonar; - a system for controlling the sonar, configured to command, for a given position of the drone, a plurality of consecutive transmissions of acoustic waves, the control system controlling the sonar transmitters so as to vary the characteristics of the transmitted acoustic waves, from one of the transmissions to the next, and - an acquisition unit configured to determine, from echo signals acquired in response to the plurality of transmissions, a three-dimensional image representing the content of a given observation volume. The invention also relates to a method for characterising an underwear environment, implemented by such a drone.

### TECHNICAL FIELD TO WHICH THE INVENTION RELATES The present invention generally relates to unmanned ships adapted to move autonomously or via remote controlling.

It also relates to a method for exploring an underwater environment.

### TECHNOLOGICAL BACK-GROUND

There is currently a strong development of unmanned ships adapted to move autonomously or via remote controlling, also called “surface marine drones”, or “drone ships”.

Such marine drones, also called “unmanned surface vehicles”, are in particular used for military use, to avoid exposing the life of a pilot.

They are also used for oceanographic purposes because, due to their mobility, they permit a more complete characterisation of a marine environment than a fixed observation buoy. Moreover, making a series of observations by means of such a drone is generally less expensive than using a conventional exploration vessel, operated by a crew.

It is known, for measuring the depth of a water column located under such a surface marine drone, or detecting the presence of fishes in this water column, to equip the drone with a sonar of the single-beam type, i.e. with a single, simple and lightweight transmitter. The article “Fish findings with autonomous surface vehicles for the pelagic fisheries”, R. Hauge et al. (Oceans 2016 MTS/IEEE Monterey, pages 1-5), for example, describes a small autonomous (unmanned) sailing ship, equipped with a single, low-energy consuming transmitter, arranged at the lower end of a keel of the sailing ship.

It is also known to equip an unmanned ship with a multi-beam sonar (provided with several transmitters and several receivers) for obtaining depth data all along a measurement line perpendicular to the longitudinal axis of the ship hull, and hence perpendicular to the travel direction of this ship. This is however far more constraining than using a single-beam sonar because the hull shape must then be adapted for installing a multi-beam ultrasound “antenna” and because this highly increases the energy consumption of the ship.

Such a multi-beam sonar conventionally comprises a set of sound or ultrasound transmitters, distributed along the longitudinal axis of the ship. These transmitters transmit a set of sound (or ultrasound) waves along respective coplanar directions of transmission, contained in a transmission plane perpendicular to the longitudinal axis of the ship. In other words, these sound waves are transmitted in a directive way, forming together a sheet (the “swath”) that extends under the ship, directly below the latter. These directions of transmission cover a given angular sector, having generally an opening of several tenth of degrees. The sound waves transmitted by the sonar reach different points of the seabed, located along the above-mentioned measurement line. Receivers, adapted to detect sound waves reflected by the seabed, then make it possible to obtain depth data for different points of this measurement line. These receivers are more precisely arranged along a line perpendicular to the longitudinal axis of the ship, which makes it possible, by combining the signals received by them, to determine from which point of the measurement line comes a given back-reflected sound wave.

Such a conventional multi-beam sonar makes it possible, when the ship moves (in straight line), to obtain, line by line, a two-dimensional image representative of the topography of the considered seabed.

### OBJECT OF THE INVENTION

In this context, the present invention proposes a surface marine drone comprising an on-board sonar, the sonar, of the multi-beam type, including a plurality of sound wave transmitters arranged along a first axis and a plurality of sound wave receivers arranged along a second axis, which is not parallel to the first axis.

According to the invention, the marine drone further comprises:
a system for controlling the sonar, configured to control, for a given position of the marine drone, a plurality of successive sound wave transmissions,

The controlling system controlling the different transmitters, at each transmission, by a respective plurality of transmission signals, each transmission signal having an amplitude and a time-shift with respect to a reference signal,
the controlling system varying the respective amplitudes or time-shifts of said transmission signals, during said plurality of transmissions, in accordance with a predetermined transmission variation sequence, all the sound waves transmitted during said plurality of transmissions covering a given observation volume, and
an acquisition unit configured to:
acquire, for each of said transmissions, echo signals captured by the receivers of the sonar in response to the considered transmission, and to
determine, from the echo signals acquired in response to said plurality of transmissions, a three-dimensional image representative of the content of the observation volume.

Unlike a conventional multi-beam sonar as shown in preamble, with the multi-beam sonar equipping the drone according to the invention, it is possible to obtain a tree-dimensional image representative of the content of the observation volume, from a given position of the drone, without require for that purpose that the latter moves.

Nowadays, the multi-beam sonars making it possible to determine a three-dimensional image of an underwater environment from a fixed position are, due to their high level of sophistication, cumbersome, heavy, energy consuming, and sometimes expensive. These features hence make them suitable for exploration or large-scale fishing vessels.

The fact that a surface marine drone is generally small size but, on the other hand, particularly mobile, is hence an incitement to equip it with a single-beam sonar, or a conventional multi-beam sonar only adapted to collect depth data along a measurement line, an image of the considered underwater environment being then obtained by displacement of the drone, as explained in preamble.

Yet, the applicant proposes to equip such a marine drone with the above-mentioned multi-beam sonar, configured to collect, from a fixed position of the drone, a three-dimensional image of its underwater environment.

The making of this marine drone is technically difficult for the reasons mentioned hereinabove. But, in compensation, this drone reveals particularly useful to monitor and characterise an underwater environment. Indeed, it makes it possible to perform such a characterisation:
in a discrete manner, thanks to the small size of the drone and to its three-dimensional sonar imaging capacity without displacement,
and that from a position of optimum observation of this environment.

In particular, the surface marine drone according to the invention makes it possible to detect, monitor and characterise a fish shoal, without disturbing it, from an optimum position, located for example in the centre of the fish shoal. This is indeed generally in the centre of such a shoal that the type of fishes met, and the concentration and behaviour thereof, are the more representative of the whole shoal.

The invention also finds a particularly interesting application in the framework of an oceanographic survey such as the determination of morphological and dynamic properties of the observed shoal, and for a localisation preliminary to a fishing operation.

Other non-limitative and advantageous features of the surface marine drone according to the invention, taken individually or according to all the technically possible combinations, are the following:
the sonar is configured so that an aspect ratio of the observation volume, equal to the smallest dimension of the observation volume divided by the largest dimension of the observation volume, is higher than 0.2;
the largest external dimension of the marine drone is lower than 2 metres;
the transmitters and receivers of the sonar are integrated to the surface marine drone hull;
the sonar comprises an electronic control unit of the transmitters and receivers housed in the hold of the surface marine drone;
the controlling system is further adapted to, previously to said plurality of sound wave transmissions, control a displacement of the surface marine drone up to said given position;
the controlling system is further adapted to:
   detect a fish shoal by processing said three-dimensional image,
   control a displacement of the surface marine drone up to another position, located directly above the fish shoal, and then
   control again said plurality of successive sound wave transmissions, the marine drone being located at said other position, the acquisition unit acquiring, for each of said transmissions, the echo signals captured by the receivers of the sonar in response to the considered transmission, and determining, from the echo signals acquired in response to said plurality of transmissions, another three-dimensional image representative of the content of the observation volume;
the controlling system is further adapted to determine a data item representative of said fish shoal, other than a position of a centre of the fish shoal, as a function of said other three-dimensional image;
the controlling system is further adapted to localise, as a function of said three-dimensional image, a centre of the fish shoal;
said other position is located directly above the fish shoal;
the respective time-shifts of said transmission signals, varying according to said transmission sequence, are such that:
   for each of said sound wave transmissions, the transmitted sound power is concentrated, by interference between the transmitted sound waves, in a transmission plane,
   between each of said transmissions and the next transmission, the transmission plane pivots about a scanning axis,
   during said plurality of sound wave transmissions, the transmission plane, due to said pivotal movements, scans the whole observation volume;
the transmitters of the sonar are N in number.

It may then be provided that said plurality of sound wave transmissions is associated, in a memory of the controlling system, with a respective plurality of lines of a matrix of rank N, and for each of said sound wave transmissions, the respective amplitudes of said transmission signals are proportional to the coefficients of the line of the matrix of rank N associated with the considered transmission.

This arrangement generally allows collecting a three-dimensional image of the observation volume content at a higher rate (i.e. within a shorter time) than with the scanning of a transmission plane.

The transmission basis, i.e. the considered matrix of rank N, may in particular correspond to:
a Hadamard matrix of rank N, or
a diagonal matrix of rank N.

It may also be provided that the first axis and the second axis are separated by an angle comprised between 60 degrees and 90 degrees, that
the transmitters are distributed, along the first axis, over at least 20 centimetres long, or even over at least 50 centimetres long, and that
the receivers are distributed, along the second axis, over at least 20 centimetres long, or even over at least 50 centimetres long.

The invention also provides a method for characterising an underwater environment implemented by a surface marine drone comprising an on-board sonar, the sonar, of the multi-beam type, including a plurality of sound wave transmitters arranged along the first axis and a plurality of sound wave receivers arranged along a second axis that is not parallel to the first axis.

According to the invention, during the method:
a system for controlling the sonar controls, for a given position of the marine drone, a plurality of successive sound wave transmissions,
the controlling system controlling the different transmitters, at each transmission, by a respective plurality of transmission signals, each signal having an amplitude and a time-shift with respect to a reference signal,
the controlling system varying the respective amplitudes or time-shifts of said transmission signals, during said plurality of transmissions, in accordance with a predetermined transmission variation sequence, all the sound waves transmitted during said plurality of transmissions covering a given observation volume,
an acquisition unit acquires, for each of said transmissions, echo signals captured by the receivers of the sonar in response to the considered transmission, and
the acquisition unit determines, from the echo signals acquired in response to said plurality of transmissions, a three-dimensional image representative of the content of the observation volume.

Other non-limitative and advantageous features of this method are the following:
an aspect ratio of the observation volume, equal to the smallest dimension of the observation volume divided by the largest dimension of the observation volume, is higher than 0.2;
during the method, the controlling system further controls, previously to said plurality of sound wave transmissions, a displacement of the surface marine drone up to said given position;
during the method, the controlling system:
   detect a fish shoal by processing said three-dimensional image,
   control a displacement of the surface marine drone up to another position, located directly above the fish shoal, and then
   control again said plurality of successive sound wave transmissions, the marine drone being located at said other position, the acquisition unit acquiring, for each of said transmissions, the echo signals captured by the receivers of the sonar in response to the considered transmission, and determining, from the echo signals acquired in response to said plurality of transmissions, another three-dimensional image representative of the content of the observation volume;
the method further comprises a step of determining a data item representative of said fish shoal, other than a position of a centre of the fish shoal, as a function of said other three-dimensional image;
during the method, the controlling system localises, as a function of said three-dimensional image, a centre of the fish shoal;
said other position is located directly above the centre of the fish shoal;
the controlling unit determines, as a function of said three-dimensional image, the respective positions of a plurality of points located on the periphery of the fish shoal, and determines a position of the centre of the fish shoal as a function of the positions of these points;
the sequence of steps of:
   controlling said plurality of successive sound wave transmissions and, for each of said transmissions, acquiring echo signals captured by the receivers of the sonar in response to the considered transmission, then determining, from the echo signals acquired in response to said plurality of transmissions, a three-dimensional image representative of the content of the observation volume,
   localising the centre of the fish shoal, and
   in case where the marine drone is offset with respect to the centre of fish shoal, displacing the marine drone up to the position directly above the centre of the fish shoal,
is executed several times in succession;
the respective time-shifts of said transmission signals, varying in accordance with said transmission sequence, are such that:
   for each of said sound wave transmissions, the transmitted sound power is concentrated, by interference between the transmitted sound waves, in a transmission plane,
   between each of said transmissions and the next transmission, the transmission plane pivots about a scanning axis,
   during said plurality of sound wave transmissions, the transmission plane, due to said pivotal movements, scans the whole observation volume.

It may also be provided that, the sonar transmitters being N in number, and said plurality of sound wave transmissions being associated, in a memory of the controlling system, with a respective plurality of lines of a matrix of rank N, for each of said sound wave transmissions, the respective amplitudes of said transmission signals are proportional to the coefficients of the line of the matrix of rank N associated with the considered transmission.

The transmission mode is in particular implemented so as to collect a three-dimensional image of the content of the observation volume within a shorter time than with the scanning of a transmission plane.

The transmission basis, i.e. the considered matrix of rank N, may in particular correspond to a Hadamard matrix of rank N. As a variant, it could correspond to a diagonal matrix of rank N or to any type of matrix of rank N, rather than to a Hadamard matrix of rank N.

### DETAILED DESCRIPTION OF AN EXEMPLARY EMBODIMENT

The following description in relation with the appended drawings, given by way of non-limitative example, will allow a good understanding of what the invention consists of and of how it can be implemented.

In the appended drawings:

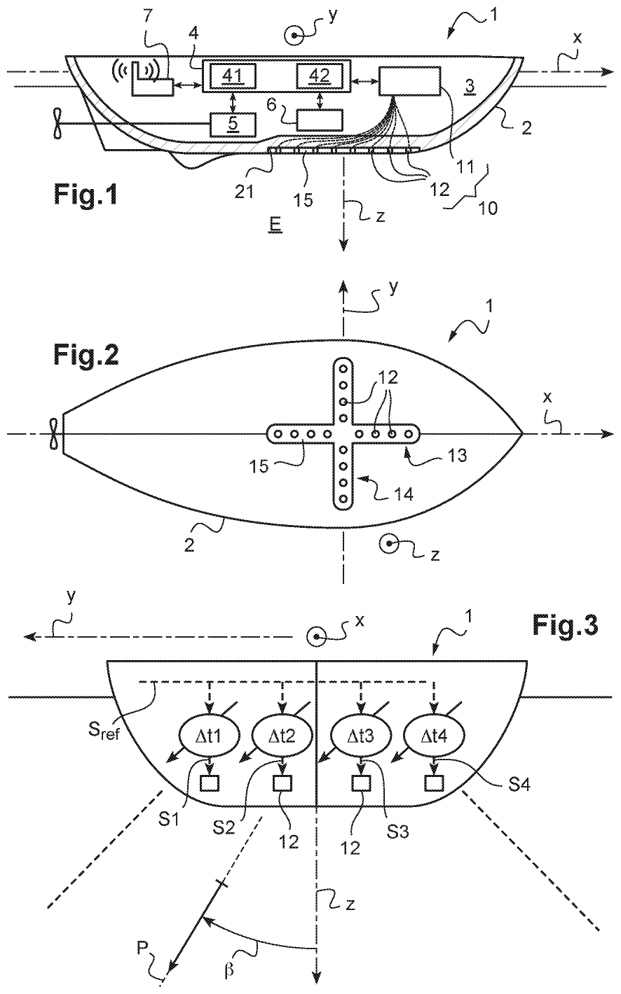

FIG. 1 is a schematic side view of a surface marine drone implementing the teachings of the invention,

FIG. 2 is a schematic top view of a surface marine drone of FIG. 1,

FIG. 3 schematically shows the features of a first embodiment of a sonar of the marine drone of FIG. 1,

FIGS. 4, 5 and 6 are respectively front, side and top view of a set of sound waves transmitted, according to this first embodiment, by the sonar of the marine drone of FIG. 1,

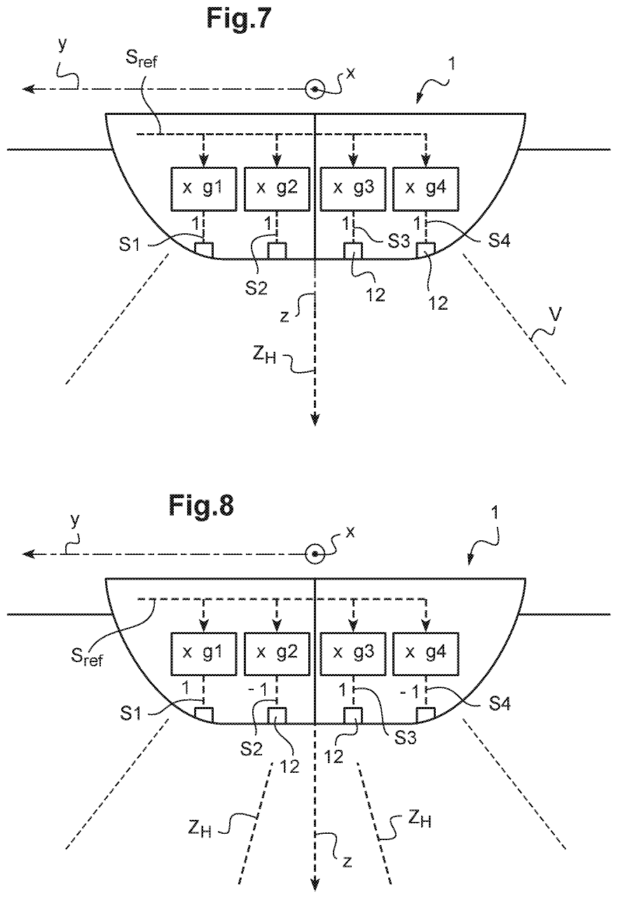

FIGS. 7 to 9 schematically show three successive sound wave transmissions made in accordance with another embodiment of a sonar of the marine drone of FIG. 1,

FIG. 10 schematically shows the main steps of a method for characterising an underwater environment, implemented by the marine drone of FIG. 1,

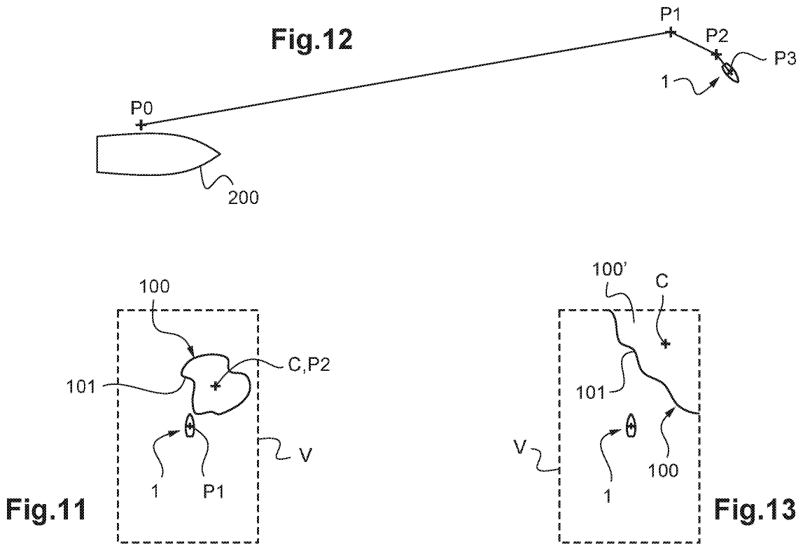

FIG. 11 is a schematic top view of a fish shoal detected by the marine drone during the method of FIG. 10,

FIG. 12 is a schematic top view of the positions successively occupied by the marine drone during the method of FIG. 10, and

FIG. 13 is a schematic top view of a fish shoal partially located in the observation volume of the surface marine drone.

FIG. 1 schematically shows the main elements of a surface marine drone 1 provided with a sophisticated multi-beam sonar 10, that is notably adapted to three-dimensionally sound the underwater environment E of the drone, without the drone has to move for that purpose.

The marine drone 1 comprises a hull 2, herein of elongated shape along a longitudinal axis x (directed from the poop to the prow of the marine drone 1).

When the marine drone moves in straight line, its direction of travel coincides with this longitudinal axis x, except for the drift effects.

As the marine drone 1 is unmanned, it may be of small size. Its largest external dimension, which herein corresponds to the total length L of its hull 2, is hence lower than 2 metres. Herein, it is more precisely comprised between 0.6 metre and 1.5 metres.

Due to its reduced size, the marine drone is particularly discrete. It hence advantageously makes it possible to monitor and/or characterise an underwater environment without disturbing it. Its small size further makes it very handy, adapted to follow the displacements of underwater species.

The sonar 10 of the marine drone, whose operating characteristics will be described hereinafter, comprises a plurality of transducers 12, and an electronic control unit 11 for these transducers 12.

The transducers 12 are adapted to transmit sound waves in the underwater environment surrounding the marine drone 1 and to receive sound waves reflected from this environment. Each of these transducers (12) is hence herein adapted to operate both as a transmitter and as a receiver. The term “sound waves” describes acoustic waves of any frequency, whether they are located in the audible domain or in the ultrasound domain.

Their control unit 11 may comprise digital-to-analog converters (for the transducers in transmission) and analog-to-digital converters (for the transducers in reception), as well as electronic amplifiers and filters adapted to shape transmission signals to be transmitted, or echo signals captured by these transducers.

The transducers 12 are arranged crosswise (FIG. 2):
some transducers are arranged one after each other along a first branch 13 of the cross, whereas
the other transducers are arranged one after each other along a second branch 14 of the cross, perpendicular to the first branch 13 thereof (so-called “Mills cross” arrangement).

The first branch 13 of the cross is herein parallel to the longitudinal axis x of the marine drone 1, whereas its second branch 14 is parallel to a transverse axis y of the drone. This transverse axis y, perpendicular to the longitudinal axis x, is parallel to the marine drone deck.

The first and second branches 13, 14 extend preferentially over more than 20 centimetres, herein over more than 50 centimetres, so that the sonar has a high angular resolution.

Usually, the transducers of a multi-beam sonar and their control unit are housed in a protection shell of the sonar, intended to be immersed, this protection shell being for example dragged behind a vessel or housed against the vessel hull.

Here, on the contrary, the transducers 12 are integrated to the hull 2 of the marine drone 1, whereas their control unit 11 is housed in the hold 3 of the drone, isolated from the marine environment (i.e. in the inner volume of the drone delimited by its hull 2). In other words, the hull 2 of the marine drone fulfils the role of protection casing of the sonar.

This arrangement makes it possible to free from a protective cover specific to the sonar, which considerably lighten the marine drone. A sufficient buoyancy of the marine drone may hence be reached, although the drone is equipped with the above-mentioned multi-beam sonar 10, intrinsically complex and heavy.

In the exemplary embodiment describe herein, the transducers 12 are held together by a support part 15 itself inserted into a shallow housing 21 arranged in the hull 2. This support part 15 facilitates the handling of the transducers 12, and the integration thereof to the hull 2 of the marine drone. It also makes it possible to conveniently test the operation of the sonar antenna, which consists of all these transducers 12, previously to the integration of this antenna to the hull 2 of the marine drone 1.

The transducers 12 are electrically connected to their control unit 11.

The marine drone 1 also comprises:
propelling means 5, such as a motor driving an immersed propeller,
an inertial sensor 6 including in particular a gyrometer,
a communication module 7 adapted to exchange data using a wireless link, such a radio-wave transceiver module, and
a navigation electronic unit 4, adapted to control the sonar 10, the propelling means 5 and the communication module 7.

The navigation electronic unit 4 comprises in particular a system 41 for controlling the sonar, and a unit 42 for acquiring the data from the sonar. The navigation electronic unit 4 is made by means of one or several processors and at least one memory. It is housed within the hold 3 of the marine drone.

Notably, the system 41 for controlling the sonar 10 is configured to control, for a given position P1, P2, P3 of the marine drone 1 (FIG. 12), a plurality of successive sound wave transmissions,
the controlling system 41 controlling the different transmitters 12, at each transmission, by a respective plurality of transmission signals S1, S2, S3, S4, . . . each transmission signal having an amplitude A1, A2, A3, A4, . . . and a time-shift Δt1, Δt2, Δt3, Δt4, . . . with respect to a reference signal Sref (FIGS. 3 and 7),
the controlling system 41 varying the respective amplitudes A1, A2, A3, A4, . . . or time-shifts Δt1, Δt2, Δt3, Δt4, . . . of said transmission signals S1, S2, S3, S4, during said plurality of transmissions, in accordance with a predetermined transmission variation sequence, all the sound waves transmitted during said plurality of transmissions covering a given observation volume V.

The acquisition unit 42 is configured to:
acquire, for each of said transmissions, echo signals captured by the receivers 12 of the sonar 10 in response to the considered transmission, and to
determine, from the echo signals acquired in response to said plurality of transmissions, a three-dimensional image representative of the content of the observation volume V.

Controlling this plurality of successive transmissions, the characteristics of the transmitted sound waves varying from one of these transmissions to the next one, advantageously makes it possible to determine this three-dimensional image, without the marine drone 10 has to move for that purpose.

Several embodiments of the sonar, each characterised by a transmission variation sequence that is specific to it, are conceivable.

A first embodiment of the sonar 10 will now be described with reference to FIGS. 3 to 6.

In this first embodiment, the respective time-shifts Δt1, Δt2, Δt3, Δt4, . . . of the transmission signals S1, S2, S3, S4, . . . controlling the transmitters 12 are such that, for each of said sound wave transmissions, the transmitted sound power is concentrated, by interference between the transmitted sound waves, in a transmission plane P.

At each transmission, the transmitted power is hence transmitted in a directive way, the transmitted sound waves forming together a shallow sound wave sheet, or “swath” (herein shallow according to the transverse axis y, as illustrated in FIGS. 4 and 5).

During the sequence of successive transmissions, which makes it possible to collect the above-mentioned three-dimensional image, the respective time-shifts Δt1, Δt2, Δt3, Δt4, . . . of said transmission signal vary so that the transmission plane P pivots about a scanning axis, from one of the sound wave transmissions to the next one.

During this transmission sequence, due to these pivotal movements, the transmission plane P scans the whole observation volume V.

The features of this first embodiment will be first described for one of said transmissions. The scanning of the transmission plane P, for collecting the above-mentioned three-dimensional image, will then be described.

The sound wave transmission is performed by the second branch 14 of transducers 12, which extends transversally with respect to the marine drone 1.

For each sound wave transmission, the transmission signals S1, S2, S3, S4, . . . are produced from a same reference signal Sref, to which are applied respective time-shifts Δt1, Δt2, Δt3, Δt4, . . .

These time-shifts Δt1, Δt2, Δt3, Δt4, . . . are proportional to respective positions of the transmitters 12, along the transverse axis y. The transmission plane P, in which the transmitted sound waves constructively interfere with each other, hence extends longitudinally with respect to the marine drone.

When these time-shifts Δt1, Δt2, Δt3, Δt4, . . . all have the same value (for example, zero), the sound waves are transmitted in phase and constructively interfere with each other in the plane (x,z) that extends under the marine drone 1, directly under the latter. In other words, the transmission plane P then corresponds to the plane (x,z).

On the other hand, when these time-shifts Δt1, Δt2, Δt3, Δt4, . . . have distinct values, certain of the sound waves are transmitted in advance, with respect to the other sound waves, so that the transmission plane P in which these sound waves constructively interfere with each other is then angularly offset with respect to the plane (x,z), as schematically shown in FIGS. 3 and 4. The inclination angle β of the transmission plane P of the sonar, formed between these plane and the vertical axis z (descending vertical axis), is hence fixed by the values of the time-shift Δt1, Δt2, Δt3, Δt4, . . .

The whole sound wave, formed by the all the transmitted sound waves (i.e. the sum of these waves), propagates in the transmission plane P by covering an angular sector S of this plane, whose angular opening a is higher than 60 degrees, and may for example reach 120 degrees (FIG. 5).

In this first embodiment, the transducers 12 of the second branch 13, parallel to the longitudinal axis x, operate in reception. They make it possible to capture sound waves reflected, as an echo, by elements of the underwater environment E reached by the above-mentioned sound wave sheet.

A moment of reception of this reflected sound wave indicates the distance between the reflecting element and the sonar. Moreover, on the basis of the echo signals respectively received by the multiple transducers 12 of the first branch 13, the acquisition unit 42 (or, as a variant, the control unit of the sonar, or also the controlling system) determines from which direction, inside the angular sector S, comes such a reflected sound wave. This direction, combined with the distance separating the reflecting element and the sonar, makes it possible to fully determine the position of the reflecting element in the transmission plane P.

All the echo signals hence captured by the receivers 12, in response to the above-mentioned sound wave transmission, hence make it possible to obtain a three-dimensional image, representative of the content of the underwater environment E of the drone in the transmission plane P. These echo signals are acquired, by the acquisition unit, during a time interval that extends between the considered sound wave transmission and the next sound wave transmission.

The angular resolution of the sonar is fixed, perpendicularly to the transmission plane P, by the angular opening θ1 of the sound wave sheet transmitted. As already indicated, this sheet is shallow (the transmission is directive, due to the extension, along the transverse axis y, of the second branch 14 of the transducers 12): its angular opening is, in practice, comprised between 0.5 and 5 degrees.

The angular resolution of the sonar in the transmission plane P, θ2, (directivity of the sonar in terms of reception) is also comprised between 0.5 and 5 degrees.

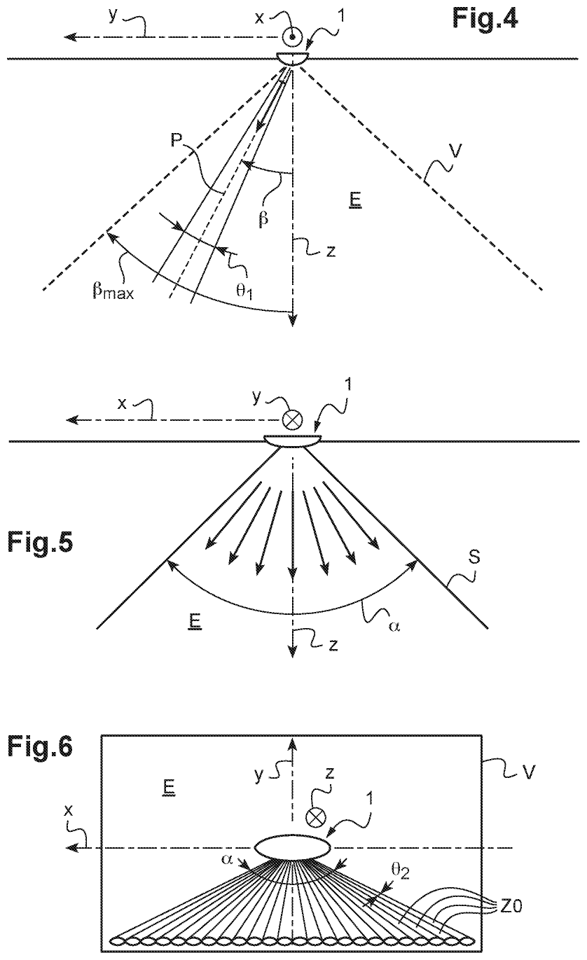

The sonar hence individually sounds the content of different elementary zones ZO, approximately conical (FIG. 6), also called “beams”, each angular openings θ1 and θ2 (respectively perpendicular and parallel to the transmission plane), distributed in the angular sector of transmission S of the sonar.

An element of the underwater element E present in one of these elementary zones can hence be detected and localized with respect to the marine drone. A data item linked to an equivalent backscattering surface of the detected element (generally called “scattering cross-section”) is also determined by the control unit 11 of the sonar, on the basis in particular of the power of the sound wave back-reflected by this element. This data item may be representative of a volume backscattering strength associated with this element, and/or a target backscattering strength of this element.

The number of distinct beams whose content is sounded that way is higher than 20. In the considered embodiment, it is more precisely equal to 64.

The detected element can correspond in particular to one or several fishes, or to a plot of the seabed located under the drone.

The scanning of the transmission plane P, that allows passing from a two-dimensional imaging as described hereinabove, to a three-dimensional imaging, can now be described.

As already indicated, this scanning is obtained by a rotation of the sonar transmission plane P with respect to the scanning axis. This scanning axis is herein parallel to the deck of the marine drone 1. The scanning axis is hence horizontal, at least in the absence of waves, when the drone is stationary.

In this first embodiment, the scanning axis coincides more precisely with the longitudinal axis x of the marine drone 1.

From one of the sound wave transmissions to the next one, to pivot the transmission plane P about this scanning axis, the controlling axis 41 varies the respective time-shifts Δt1, Δt2, Δt3, Δt4, . . . of the different transmission signals S1, S2, S3, S4, . . . with respect to the reference signal Sref.

During the sound wave transmission sequence, which allows collecting the above-mentioned three-dimensional image, the controlling system 41 hence varies the inclination angle β of the transmission plane P between two limit inclination angles +βmax and −βmax. In practice, the angular amplitude 2βmax of this scanning can be higher than 60 degrees. Herein, it may reach 120 degrees.

The three-dimensional image determined by the acquisition unit 42, on the basis of the echo signals acquired in response to this sound wave transmission sequence is representative of the content of each of the elementary zones ZO of the so-scanned observation volume V. This image gathers in particular information relating to the positions (in a three-dimensional reference system such, for example, as the reference system (x,y,z)) and the equivalent backscattering surfaces of the elements contained in this observation volume V.

Thanks to its small size and its three-dimensional sonar imaging capacity without displacement, the marine drone 1 makes it possible to monitor and characterise an underwater environment, in a discrete manner, without disturbing the latter, and from an optimum observation position.

Moreover, through optimisation of the sonar energy consumption, this three-dimensional image can in practice be obtained for an energy consumption lower than necessary to acquire such an image by displacement (at the surface of water) of a drone provided with a conventional multi-beam sonar without scanning capacity.

The opening a of the angular sector of transmission S of the sonar, and the scanning amplitude 2βmax, both particularly high, make it possible, even at a shallow depth under the drone, to sound a region that is horizontally very extended, which is very useful for the detection and observation of aquatic species moving in a column of water extending under the marine drone.

In view of the shape of the sound wave sheet transmitted by the sonar 10, the observation volume V has herein a generally pyramidal shape (each side of the base of this pyramid being either rectilinear or formed of a hyperbolic arc), with, at its apex, the sonar 10. This volume is vertically limited by the seabed or, if the aquatic environment is very deep, by the sonar range (herein longer than 500 metres).

Taking into account the values that can be taken by the opening a of the angular sector of transmission S, and by the scanning amplitude 2βmax, the aspect ratio of the observation volume V, equal to its smaller dimension (for example, its height) divided by its largest dimension (for example, its length), may herein be higher than 0.2. In a horizontal plane, the ratio between the width and the length of the observation volume (dimensions of this volume, respectively along the transverse axis y and the longitudinal axis x) can be higher than 0.5. The observation volume has then a comparable extent in all the directions of the horizontal plane, without favouring arbitrarily a given observation direction.

The above-mentioned elementary zones ZO of the observation volume V correspond to approximately conical zones, as defined hereinabove, angularly offset with respect to each other about the transverse axis y, and also thanks to the above-mentioned scanning, about the longitudinal axis x.

When the inclination angle β of the transmission plane P is close to one of the limit inclination angles ±βmax, the imprint on the seabed of the sheet formed by all the transmitted sound waves may be slightly curved, of hyperbolic shape, instead of being rectilinear. The sonar transmission plane P then corresponds to the mean plane defined by this sound wave sheet (which propagates along a slightly curved instead of planar surface, whose intersection with the seabed is the above-mentioned hyperbolic imprint).

The scanning of the inclination angle β may be made very finely: this angle may for example take, in succession, up to 64 different values distributed between the limit inclination angles ±βmax; 64 successive sound wave transmissions are then necessary to obtain a three-dimensional image of the observation volume V.

However, the time required to obtain such an image increases with the number of transmissions performed to obtain this image. Indeed, two transmissions of such a sequence must be separated by a minimum time, approximately corresponding to the round-trip propagation time of a sound wave along the whole height of the observation volume.

To reduce the time required to obtain such an image, the controlling system 41 can hence be programmed to control a more basic scanning of the observation volume V, in which the inclination angle β takes successively at most 10 different values (and at least 2) distributed between the limit inclination angles ±βmax. The so-obtained image of the observation volume V is less detailed (it is nevertheless sufficient for certain applications, for example for a first localisation of a fish shoal). In return, this simplified operation allows reducing the power consumption of the sonar 10 and hence improving the autonomy of the marine drone 1.

The controlling system 41 is moreover configured in order, in case of detection of an element located at shallow depth under the marine drone 1, to control a focusing, to this element, of the sound waves transmitted by the transducers.

This focusing makes it possible in particular to compensate for different spurious effects (caused by the Fresnel diffraction, for example) that, in the so-called near field zone located immediately under the marine drone 1 (this area extends herein over about ten metres under the drone), could disturb the operation of the sonar 10. This focusing makes it possible, in particular, to hold the above-mentioned backscattering strength measurements with a reliable and calibrated character, even at shallow depth, from 1 metre under the marine drone 1. The marine drone 1, which is adapted, due to its small size, to approach species moving at shallow depth, without disturbing them, hence permits a precise observation and characterisation of such species.

The above-mentioned focusing may, for example, be performed by means of a focusing module (not shown) of the control unit 11 introducing, between the signals respectively sent to the different transducers 12 and/or received from them, respective delays (varying quadratically as a function of the position of the considered transducer), suitable to focus the transmitted sound waves to the detected element, or to compensate for phase-shifts between the different signals received, caused by the proximity of this element.

Moreover, the acquisition unit 42 (or, as a variant, the control unit 11) is configured in order, thanks to the inertial sensor 6, to detect spurious movements of the marine drone 1, for example roll and pitch movements, and to process the acquired data to compensate for the influence of such movements on the obtained three-dimensional image.

The sonar 10 is moreover configured to operate according to other embodiments than the just-described first embodiment. This flexibility of use is permitted in particular by the fact that its transducers 12 can operate both in transmission and in reception.

Hence, in a second embodiment of the sonar 10, similar to the first embodiment, the transducers 12 of the first branch 13 of the Mills cross operate in transmission, whereas those of the second branch 14 operate in reception.

This second embodiment is comparable in every respect to the first embodiment, except that:
the transmitted sound wave sheet extends transversely with respect to the marine drone (instead of extending longitudinally with respect to the latter), and
the scanning axis coincides with the transverse axis y of the marine drone 1.

As mentioned hereinabove, when the three-dimensional image of the observation volume is collected thanks to a rotation of the transmission plane about its scanning axis, a compromise must be found between the resolution of this image and the time required for its acquisition.

A better compromise between resolution and acquisition time may be found by controlling the transducers 12 according to more sophisticated transmission and reception schemes, as that of the third embodiment described hereinafter, with reference to FIGS. 7 to 9.

This third embodiment may be used in particular when the number N of transmitters is equal to 2^{p}, where p is an integer. The receivers are also N in number.

For each sound wave transmission, the transmission signals S1, S2, S3, S4, . . . are produced from a same reference signal Sref, multiplied by respective gains g1, g2, g3, g4, . . . (FIG. 7). The transmission signals hence have amplitudes A1, A2, A3, A4, . . ., respectively proportional to the gains g1, g2, g3, g4. Moreover, these transmission signals have no time-shift with respect to each other (in other words, the time-shifts Δt1, Δt2, Δt3, Δt4, . . . of these signals with respect to the reference signal Sref all have the same value).

Each sound wave transmission sequence, which allows collecting a three-dimensional image, comprises a number M of transmissions. Each of these transmissions is marked, in this sequence, with an integer index (order number) I, the index i varying from 1 to M.

The values of the gains g1(i), g2(i), . . . , gN(i), i varying from 1 to M, applied to produce the transmission signals S1, S2, S3, S4, . . . that control the transmitters 12 during this transmission sequence, are stored in a memory of the controlling system 41.

The transmission sequence is more precisely associated, in this memory, with a respective plurality of lines of a matrix of rank N.

Hence, the i-th transmission of this sequence is associated with the j-th line of this matrix. The values of the gains g1(i), g2(i), . . . , gN(i), stored in the memory of the controlling system, are then proportional to the coefficients of the line number j of this matrix of rank N. The transmission variation sequence is hence defined, in this third embodiment, by the data of the M lines of the matrix of rank N respectively associated with the M transmissions of each transmission sequence.

In this third embodiment, different matrix of rank N, i.e. different transmission bases, can be contemplated.

Preferably, the transmission base used is the so-called Hadamard one, for which the above-mentioned matrix of rank N is the Hadamard matrix of rank N.

It may for example be provided that the transmission number i is associated with the line number i of this Hadamard matrix, i.e. j=i.

By way of example, it may also be provided, as a variant, that: j=1 for i=1, and that j=2i−1 for i>1.

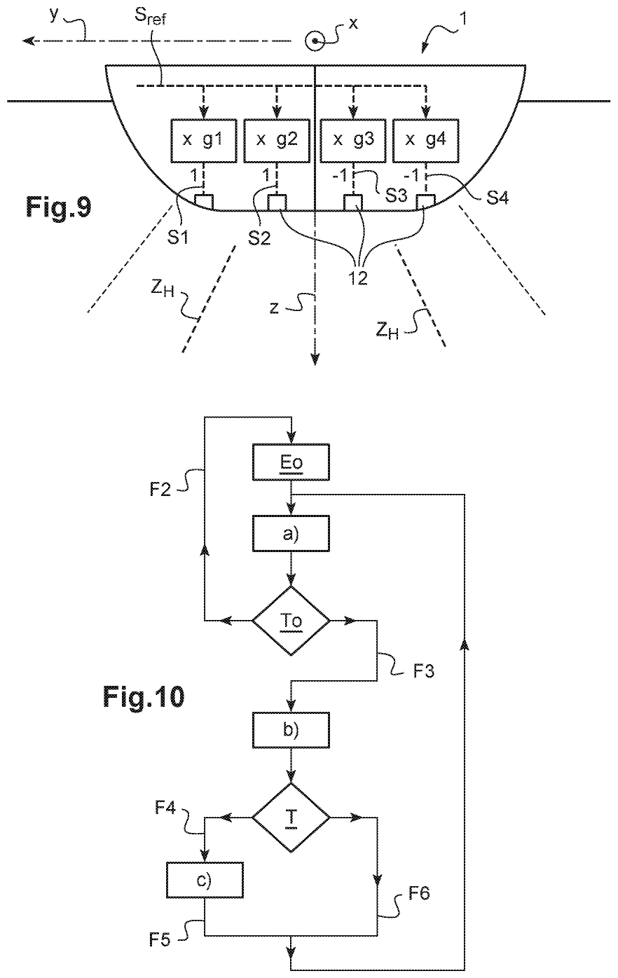

By way of illustration, a simplified example of transmission sequence is shown in FIGS. 7 to 9, for N=4 transmitters and M=3 transmissions:
for the first sound wave transmission (i=1), associated with line 1 (j=1) of the Hadamard matrix of rank 4 (FIG. 7):
   g1(1)=1; g2(1)=1; g3(1)=1; g4(1)=1;
for the second sound wave transmission (i=2), associated with line 2 (j=2) of this matrix (FIG. 8):
   g1(2)=1; g2(2)=−1; g3(2)=1; g4(2)=−1; and
for the third sound wave transmission (i=3), associated with line 2 (j=2) of this matrix (FIGS. 9):
   g1(3)=1; g2(3)=1; g3(3)=−1; g4(3)=−1.

The zones Z_{H} of the observation volume V where the transmitted sound power is maximum (due to the interferences between the transmitted sound waves) are schematically shown by dashes (thick line), in these figures.

During such a transmission sequence, varying the amplitude of the transmission signals in accordance with the coefficients of the different lines of a Hadamard matrix of rank N makes it possible, for a given spatial resolution, to collect a three-dimensional image of the observation volume V in a time that is advantageously shorter than that which would be obtained by rotation of a transmission plane (or also by an opening synthesis method sometimes called canonical method, succinctly described hereinafter).

For that purpose, it may also be provided, in particular, that the number M of transmissions per image (three-dimensional) is lower than the number N of transmitters 12. The applicant has indeed noticed that this reduction of the number of transmissions (that reduces accordingly the time required for obtaining an image) degrades only very slightly the resolution of the image with respect to an image reconstructed from a sequence of N transmissions (and associated receptions).

It is particularly interesting to hence reduce the number of transmissions required to acquire an image, because this allows reducing the energy consumption of the sonar 10, and hence increasing the autonomy of the marine drone 1.

Moreover, for the applications of fish shoal tracking described hereinafter, it is interesting that such an image can be acquired rapidly, to avoid in particular that the shoal 100 exits from the observation volume V between an image acquisition and the next one.

As already indicated, other transmission bases than the Hadamard one may be used. It may be provided, for example, at each transmission, to control only one of the transmitters 12, and to change of transmitter between a transmission and the next one (transmission method sometimes called canonical method in the specialized literature). The matrix of rank N, in the memory of the controlling system, associated with the plurality of sound wave transmissions, is then a diagonal matrix (for example, the identity matrix).

The multi-beam sonar 10 of the marine drone 1 having been presented, the whole operation of this drone can now be described in more details.

First, the navigation electronic unit 4 is programmed to control the drone:
as a function of commands given by a remote operator, received through the communication module 7, and/or
autonomously, without external intervention.

When the marine drone 1 is remote-controlled by this operator, the navigation unit 4 transmits, thanks to its communication module 7, compressed data produced based on the data from the sonar 10, in particular based on the three-dimensional image(s) of the marine environment of the drone collected by means of the sonar. These (compressed) data allow in particular the operator to visualize, at least in part, the content of the underwater environment E of the drone, and to adapt its controlling of the drone to this content. The compression of the data from the sonar 10 (performed, for example, by the navigation electronic unit 4) allows limiting the quantity of data to be transmitted, and here again reducing the power consumption of the drone.

Here, the navigation electronic unit 4 is moreover programmed to record the data from the sonar in its memory. These data may be compressed previously to their storage, to limit the memory space they occupied. The compression rates then used are however lower than those used to produce the compressed data to be transmitted: the stored data, complementary of the transmitted data, allow, a posteriori, a finer analysis of the underwater environment E than the data transmitted in real time to allow the controlling of the drone.

When the marine drone 1 sails autonomously, without external intervention, the navigation electronic unit 4 records the data from the sonar, as explained hereinabove. It can also, as an option, transmit the above-mentioned compressed data via the communication module 7.

The displacements of the marine drone 1, and the corresponding acquisitions of three-dimensional images of the underwater environment E, intended to be performed during operations of observation and characterisation of this environment, will now be described with reference to FIGS. 10 to 13.

FIG. 10 schematically shows the main steps of a method for characterising an underwater environment E, implemented by a surface marine drone as described hereinabove.

The method may be implemented:
due to a remote controlling, by an operator, of the marine drone, et/or
autonomously, the navigation electronic unit of the drone being then programmed to execute this method without external intervention.

The method starts with an optional step E0 of displacement of the marine drone up to a first observation position P1. This displacement, controlled by the navigation electronic unit 4, is made thanks to the above-mentioned displacement means 5.

This first position P1 (FIGS. 11 and 12) corresponds to a target position near which fishes or marine animals are likely to be present. This first position is located for example near a floating device, generally called fish concentration device (“DCP”, from the French “Dispositif de Concentration de Poisson”), which gathers about it a pelagic fauna moving a shallow depth. This first step allows for example the marine drone 1 to move from an initial position P0, at which it has been launched, near a vessel 200 of higher tonnage manoeuvred by a crew, up to this observation position P1.

The method continues with a step a) of acquiring a three-dimensional image of the underwater environment E, i.e. a step in which the controlling system 41 controls the plurality of successive sound wave transmissions, the acquisition unit 42 acquiring, for each of said transmissions, the echo signals captured by the receivers 12 of the sonar 10 in response to the considered transmission, and determining, from the echo signals acquired in response to said plurality of transmissions, a three-dimensional image representative of the content of the observation volume V.

The next step T0, optional, is a test step during which it is determined if fishes are present in this observation volume V.

If no fish is detected in the observation volume, the method resumes, at step E0 (arrow F2 of FIG. 10), with a displacement of the marine drone towards another target position. Several distinct target positions can hence be successively tested until the presence of a marine population is detected by the sonar. Optionally, it can be provided to test, at step T0, if the detected fish shoal fulfils a given criterion, relating for example to a density of fishes in this shoal, and if this criterion is not fulfilled, to perform again the step E0.

In case of detection of fishes in the observation volume V, the method continues, after step T0, with steps aiming at characterising more finely the detected fish shoal 100 (arrow F3 of FIG. 10).

The steps comprise:
a step b) of determining a position of the fish shoal 100, by processing the three-dimensional image acquired during the previous execution of step a),
a step c) of displacing the surface marine drone 1 up to a position P2, P3, . . ., located directly above said position of the fish shoal 100, and again
step a) of acquiring a three-dimensional image of the underwater environment E.

During this repetition of step a), the marine drone 1 is hence located directly above, i.e. vertically above, the position of the fish shoal 100, this position being particularly suitable for observing and characterising this fish shoal 100.

The position of the fish shoal 100 determined at step b) herein corresponds to a centre C of this fish shoal 100. It is very interesting that the marine drone 1 hence acquires three-dimensional images of this shoal, by being located vertically above the centre C thereof, because this is indeed generally at the centre of such a shoal that the type of fishes met, and the concentration and behaviour thereof, are the more representative of the whole shoal. This is also from this position that the dimensions of the shoal can be determined with the highest precision.

The capacity of the marine drone 1 to acquire three-dimensional images of the aquatic environment, without having to move for that purpose, proves to be extremely useful in this method.

Indeed, such a three-dimensional image is acquired by the marine drone 1 far more rapidly (and discreetly) than what would be obtained by displacing at the surface of water a drone provided with a conventional multi-beam sonar having no scanning capacity. This rapidity of acquisition allows in particular determining almost instantaneously the position of the fish shoal and controlling a displacement of the marine drone up to be directly above this position before the fish shoal has time to substantially move away.

Moreover, as already indicated, this three-dimensional imaging capacity allows the marine drone 1 to observe the whole detected fish shoal 100 by remaining directly above the latter, which is the most favourable in terms of observation of the shoal.

Steps b) and c) will now be described in more detail, in the case of an autonomous navigation of the marine drone 1.

During step b), to localise the centre C of the fish shoal 100, the controlling system 41:
determines, by processing the three-dimensional image acquired during the previous execution of step a), the respective positions of a plurality of points located on the periphery 101 of the fish shoal 100, then
determines a position of the centre C of the fish shoal as a function of the positions of these points, for example by calculating the position of a barycentre of these points (i.e. by calculating a mean position defined by these points).

The positions of the points of the periphery 101 of the fish shoal can be determined by means of a contour detection algorithm.

It can be provided, as a variant, that the centre C of the fish shoal be determined, at step b), by directly calculating the position of a barycentre of the different points of the observation volume V at which one or several fishes have been detected, rather than by previously detecting the periphery of the shoal.

If only a part 100′ of the fish shoal 101 is located in the observation volume V (situation schematically shown in FIG. 13), this is the position of the centre C of this part 100′ of the fish shoal that is herein determined at step b) by the controlling system 41.

Step b) is followed with a test step T, in which the controlling system 41 determines if the surface marine drone 1 is located vertically above the centre C of the fish shoal 100. If so, the method resumes with step a) (arrow F6 of FIG. 10).

On the other hand, if step T shows that the marine drone 1 is offset, in the horizontal plane (x,y), with respect to the centre C of the fish shoal, the method then continues with step c) of displacing the marine drone 1 up to be directly above the centre C of the fish shoal (arrow F4 of FIG. 10). The method then resumes with step a) (arrow F5 of FIG. 10).

All steps a), b), T, and as the case may be, c), are then executed again, and so on, several times in succession.

Repeating continuously this sequence of steps allows the marine drone 1 to stay above the centre C of the fish shoal, and to track a potential displacement of this centre.

FIG. 12 schematically illustrates such a tracking. The marine drone 1, launched at the initial position P0, is first displaced up to the first position of observation P1. From this first position, it acquires a three-dimensional image of its aquatic environment. That image shows that a fish shoal 100 is present in the observation volume V (FIG. 11) and allows determining the centre C thereof. The marine drone then moves up to a second position P2 located directly above this centre. Then, after a subsequent displacement of the fish shoal, the marine drone adjusts its position by moving up to a third position P3 (located directly above a new position occupied by the centre of the shoal), and so on.

The controlling system 41 of the marine drone 1 is further programmed, herein, in order, after step a), to execute a step d) of determining at least one data item representative of the fish shoal 100, other than the position of its centre, as a function of the data acquired by the acquisition unit 42 at step a).

Said data item may for example relate to the dimensions of the fish shoal (width, length, height, volume, . . . ), to its morphology, to a density or to a number of fishes in the shoal (wherein such an estimation can be based, in particular, on the above-mentioned measurements of backscattering strength), or to a mobility of these fishes.

Different modifications may be made to the just-described marine drone 1 and characterisation method.

First, the cross according to which the sonar transducers are arranged could be aligned differently with respect to the marine drone. The branches of this cross could for example be arranged at 45 degrees between the longitudinal axis and the transverse axis of the marine drone, instead of being aligned with these latter. The transducers could also be arranged according to a grid (matrix), instead of a cross.

On the other hand, the different functions of the controlling system, of the acquisition unit, and of the control unit of the transducers could be distributed differently between these units. For example, the fish shoal centre position could of course be determined by the acquisition unit rather than by the controlling system. Besides, the controlling and acquisition units could be made by means of a same electronic module of the navigation electronic unit of the marine drone.

The control unit of the transducers could moreover also be integrated to the navigation electronic unit.

Moreover, other modes of tracking of the shoal centre could be contemplated. For example, several prior positions of the fish shoal centre could be taken into account to determine a future position at which the fish shoal will probably be located (the drone being then controlled up to this position).

1. A surface marine drone comprising an on-board sonar, the sonar, of the multi-beam type, including a plurality of sound wave transmitters arranged along a first axis and a plurality of sound wave receivers arranged along a second axis, which is not parallel to the first axis, wherein said surface marine drone further comprises:
a system for piloting the sonar, configured to control, for a given position of the marine drone, a plurality of successive sound wave transmissions,
the piloting system piloting the different transmitters, at each transmission, by a respective plurality of transmission signals, each transmission signal having an amplitude and a time-shift with respect to a reference signal,
the piloting system varying the respective amplitudes or time-shifts of said transmission signals, during said plurality of transmissions, in accordance with a predetermined transmission variation sequence, all the sound waves transmitted during said plurality of transmissions covering a given observation volume, and
an acquisition unit configured to:
acquire, for each of said transmissions, echo signals captured by the receivers of the sonar in response to the considered transmission, and to
determine, from the echo signals acquired in response to said plurality of transmissions, a three-dimensional image representative of the content of the observation volume.

2. The surface marine drone according to claim 1, wherein the sonar is configured so that an aspect ratio of the observation volume, equal to the smallest dimension of the observation volume divided by the largest dimension of the observation volume, is higher than 0.2.

3. The surface marine drone according to claim 1, whose largest external dimension is lower than 2 metres.

4. The surface marine drone according to claim 1, wherein the transmitters and receivers of the sonar are integrated to the hull of the surface marine drone, and wherein the sonar comprises an electronic control unit of the transmitters and receiver housed in the hold of the surface marine drone.

5. The surface marine drone according to claim 1, wherein the piloting system is further adapted to, previously to said plurality of sound wave transmissions, control a displacement of the surface marine drone up to said given position.

6. The surface marine drone according to claim 5, wherein the piloting system is further adapted to:
detect a fish shoal by processing said three-dimensional image,
control a displacement of the surface marine drone up to another position, located directly above the fish shoal, and then
control again said plurality of successive sound wave transmissions, the marine drone being located at said other position, the acquisition unit acquiring, for each of said transmissions, the echo signals captured by the receivers of the sonar in response to the considered transmission, and determining, from the echo signals acquired in response to said plurality of transmissions, another three-dimensional image representative of the content of the observation volume.

7. The surface marine drone according to claim 6, wherein the piloting system is further adapted to determine a data item representative of said fish shoal, other than a position of a centre of the fish shoal, as a function of said other three-dimensional image.

8. The surface marine drone according to claim 6, wherein the piloting system is further adapted to localise, as a function of said three-dimensional image, a centre of the fish shoal, and wherein said other position is located directly above the centre of the fish shoal.

9. The surface marine drone according to claim 1, wherein the respective time-shifts of said transmission signals, varying according to said transmission sequence, are such that:
for each of said sound wave transmissions, the transmitted sound power is concentrated, by interference between the transmitted sound waves, in a transmission plane,
between each of said transmissions and the next transmission, the transmission plane pivots about a scanning axis,
during said plurality of sound wave transmissions, the transmission plane, due to said pivotal movements, scans the whole observation volume.

10. The surface marine drone according to claim 1, wherein:
the transmitters of the sonar are N in number,
wherein said plurality of sound wave transmissions is associated, in a memory of the piloting system, with a respective plurality of lines of a Hadamard matrix of rank N, and wherein
for each of said sound wave transmissions, the respective amplitudes of said transmission signals are proportional to the coefficients of the line of the Hadamard matrix associated with the considered transmission.

11. The surface marine drone according to claim 1, wherein:
the first axis and the second axis are separated by an angle comprised between 60 degrees and 90 degrees,
the transmitters are distributed, along the first axis, over at least 20 centimetres long, and wherein
the receivers are distributed, along the second axis, over at least 20 centimetres long.

12. A method for characterising an underwater environment implemented by a surface marine drone comprising an on board sonar, the sonar, of the multi-beam type, including a plurality of sound wave transmitters arranged along a first axis and a plurality of sound wave receivers arranged along a second axis that is not parallel to the first axis, wherein, during the method:
a system for piloting the sonar control, for a given position of the marine drone, a plurality of successive sound wave transmissions,
the piloting system piloting the different transmitter, at each transmission, by a respective plurality of transmission signals, each transmission signal having an amplitude and a time-shift with respect to a reference signal,
the piloting system varying the respective amplitudes or time-shifts of said transmission signals, during said plurality of transmissions, in accordance with a predetermined transmission variation sequence, all the sound waves transmitted during said plurality of transmissions covering a given observation volume,
an acquisition unit acquires, for each of said transmissions, echo signals captured by the receivers of the sonar in response to the considered transmission, and
the acquisition determines, from the echo signals acquired in response to said plurality of transmissions, a three-dimensional image representative of the content of the observation volume.

13. The characterisation method according to claim 12, wherein an aspect ratio of the observation volume, equal to the smallest dimension of the observation volume divided by the largest dimension of the observation volume, is higher than 0.2.

14. The characterisation method according to claim 12, wherein the piloting system further controls, previously to said plurality of sound wave transmissions, a displacement of the surface marine drone up to said given position.

15. The characterisation method according to claim 14, wherein the piloting system:
detects a fish shoal by processing said three-dimensional image,
controls a displacement of the surface marine drone up to another position, located directly above the fish shoal, and then
controls again said plurality of successive sound wave transmissions, the marine drone being located at said other position, the acquisition unit acquiring, for each of said transmissions, the echo signals captured by the receivers of the sonar in response to the considered transmission, and determining, from the echo signals acquired in response to said plurality of transmissions, another three-dimensional image representative of the content of the observation volume.

16. The characterisation method according to claim 15, further comprising a step of determining a data item representative of said fish shoal, other than a position of a centre of the fish shoal, as a function of said other three-dimensional image.

17. The characterisation method according to claim 16, wherein the piloting system localises, as a function of said three-dimensional image, the centre of the fish shoal, and wherein said other position is located directly above the centre of the fish shoal.

18. The characterisation method according to claim 17, wherein the piloting system determines, as a function of said three-dimensional image, the respective positions of a plurality of points located on the periphery of the fish shoal, and determines a position of the centre of the fish shoal as a function of the positions of these points.

19. The characterisation method according to claim 17, wherein the sequence of steps of:
controlling said plurality of successive sound wave transmissions and, for each of said transmissions, acquiring echo signals captured by the receivers of the sonar in response to the considered transmission, then determining, from the echo signals acquired in response to said plurality of transmissions, a three-dimensional image representative of the content of the observation volume,
locating the centre of the fish shoal, and
in case where the marine drone is offset with respect to the centre of the fish shoal, displacing the marine drone up to the position directly above the centre of the fish shoal,
is executed several times in succession.

20. The surface marine drone according to claim 1, further configured in order, after having determined said three-dimensional image representative of the content of the observation volume, to determine whether fishes are present in the acquisition volume, and if no fish is detected in the observation volume, to move to another position, in order to successively test several distinct positions until the presence of a marine population is detected by the sonar.
